(19) United States
(12) Patent Application Publication
(10) Pub. No.: US 2015/0334622 A1
(43) Pub. Date: Nov. 19, 2015

(54) Apparatus and Method to Perform LTE/WLAN Handoff by Keeping LTE Attached or in Suspended State

(71) Applicant: Broadcom Corporation, Irvine, CA (US)

(72) Inventors: Florin BABOESCU, Solana Beach, CA (US); Dutt KALAPATAPU, Santa Clara, CA (US); Kamesh MEDAPALLI, San Jose, CA (US); Hannu HIETALAHTI, Kiviniemi (FI); Shao-Cheng WANG, Santa Clara, CA (US)

(73) Assignee: Broadcom Corporation, Irvine, CA (US)

(21) Appl. No.: 14/714,782

(22) Filed: May 18, 2015

Related U.S. Application Data
(60) Provisional application No. 62/000,456, filed on May 19, 2014.

(51) Int. Cl. H04W 36/22; H04W 88/06; H04W 36/14

(52) U.S. Cl. CPC H04W 36/22; H04W 36/14; H04W 88/06; H04W 84/12

(57) ABSTRACT

Systems and methods are disclosed to provide offloading procedures that reduce signaling load. Specifically, embodiments of the present disclosure provide offloading techniques that enable signaling overhead caused by attachment procedures to be avoided when user equipment (UE) reconnects to a cellular network after offloading data to a Wireless Local Area Network (WLAN). According to an embodiment, at least one Public Data Network (PDN) is kept connected through the cellular network access when other PDN connections are offloaded to WLAN. According to another embodiment, a PDN connection through cellular network access is suspended, rather than detached, when data is offloaded to WLAN.

### CROSS REFERENCE TO RELATED APPLICATIONS

This application claims the benefit of U.S. Provisional Patent Application No. 62/000,456, filed on May 19, 2014, which is incorporated by reference herein in its entirety.

### FIELD OF THE DISCLOSURE

This application relates generally to wireless communications, including offloading within a communication environment.

### BACKGROUND

Inter-system offloading solutions are used to alleviate congestion within communication environments by, for example, delivering data originally targeted for cellular networks to one or more other complementary technologies such as Wireless Local Area Network (WLAN) technology. Inter-system offloading can reduce congestion issues and provide flexible bandwidth for load-balancing.

### BRIEF DESCRIPTION OF THE DRAWINGS/FIGURES

The accompanying drawings, which are incorporated in and constitute part of the specification, illustrate embodiments of the disclosure and, together with the general description given above and the detailed descriptions of embodiments given below, serve to explain the principles of the present disclosure. In the drawings:

FIG. 1 illustrates an example network environment for offloading in accordance with an embodiment of the present disclosure;

FIG. 2 illustrates a base station according to an exemplary embodiment of the present disclosure;

FIG. 3 illustrates an access point according to an exemplary embodiment of the present disclosure;

FIG. 4 illustrates a mobile communication device according to an exemplary embodiment of the present disclosure;

FIG. 5 illustrates an exemplary 3GPP network environment for offloading in accordance with an embodiment of the present disclosure;

FIG. 6A is a diagram illustrating attach procedures;

FIG. 6B is a diagram illustrating Public Data Network (PDN) connection procedures;

FIG. 7 is a diagram illustrating offloading using a detach and reattach procedure;

FIG. 8A is a diagram illustrating an offloading procedure that keeps at least one PDN always connected to a cellular network in accordance with an embodiment of the present disclosure;

FIG. 8B is a flowchart of a method for an offloading procedure that keeps at least one PDN always connected to a cellular network in accordance with an embodiment of the present disclosure;

FIG. 9A is a diagram illustrating an offloading procedure using a suspend and resume technique in accordance with an embodiment of the present disclosure;

FIG. 9B is a flowchart of a method for an offloading procedure using a suspend and resume technique in accordance with an embodiment of the present disclosure; and

FIG. 10 illustrates a block diagram of an example computer system that can be used to implement aspects of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the following description, numerous specific details are set forth to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of this discussion, the term “module” shall be understood to include one of computer instructions, or firmware, or hardware (such as circuits, microchips, processors, or devices, or any combination thereof), or any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

### 1. COMMUNICATION ENVIRONMENT

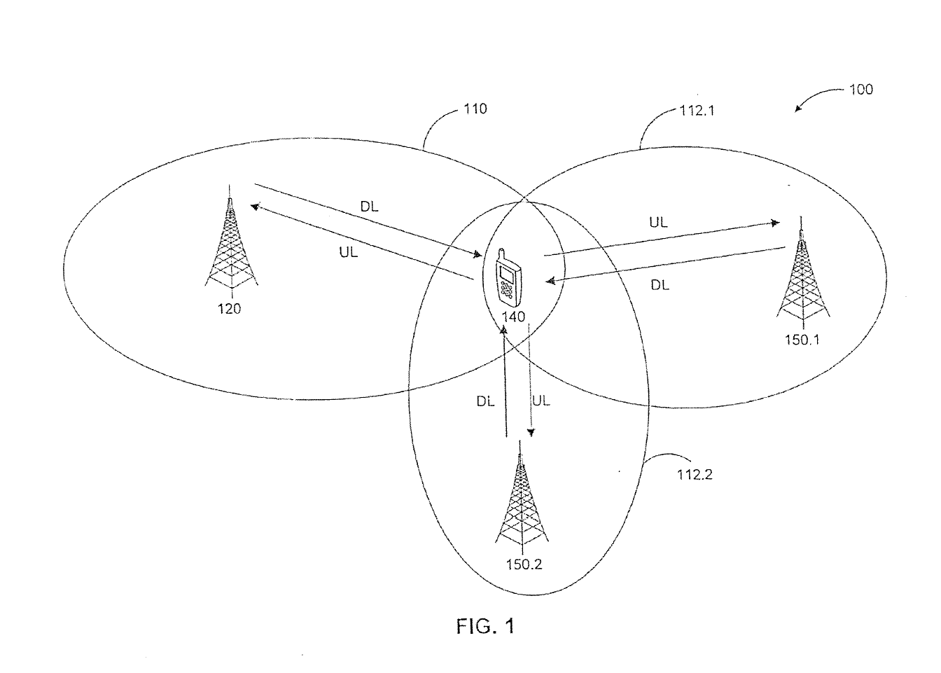

FIG. 1 illustrates an example communication environment 100 that includes one or more base stations 120, one or more mobile communication devices 140, and one or more access points (APs) 150. The base station(s) 120, mobile communication device(s) 140, and AP(s) 150 each include one or more processors, circuitry, and/or logic that is configured to communicate via one or more wireless technologies. The one or more processors can include (and be configured to access) one or more internal and/or external memories that store instructions and/or code that, when executed by the processor(s), cause the processor(s) to perform one or more operations to facilitate communications via one or more wireless technologies as discussed herein. Further, one or more of the mobile communication devices 140 can be configured to support co-existing wireless communications. The mobile communication device(s) 140 can include, for example, a transceiver having one or more processors, circuitry, and/or logic that is configured to transmit and/or receive wireless communications via one or more wireless technologies within the communication environment 100.

The base station(s) 120 and AP(s) 150 each include one or more processors, circuitry, and/or logic that is configured to: (1) receive one or more wired communications via one or more well-known wired technologies (e.g., within a core (backhaul) network) and transmit one or more corresponding wireless communications via one or more wireless technologies within the communication environment 100, (2) receive one or more wireless communications within the communication environment 100 via one or more wireless technologies and transmit one or more corresponding wired communications via one or more well-known wired technologies within a core network, and (3) to transmit and/or receive wireless communications via one or more wireless technologies within the communication environment 100. The wireless technologies can include, for example, one or more wireless protocols discussed above. The number of mobile communication devices 140, base stations 120 and/or APs 150 are not limited to the numbers shown in the exemplary embodiment illustrated in FIG. 1, and the communication environment 100 can include any number of mobile communication devices 140, base stations 120 and/or APs 150 as would be understood by those skilled in the relevant arts without departing from the spirit and scope of the present disclosure.

The mobile communication device 140 can be configured to communicate with the base station 120 in a serving cell or sector 110 of the communication environment 100, to communicate with the access point (AP) 150.1 in a wireless local area network (WLAN) 112.1 and/or to communicate with the AP 150.2 in a WLAN 112.2. For example, the mobile communication device 140 receives signals on one or more downlink (DL) channels and transmits signals to the base station 120, AP 150.1 and/or the AP 150.2 on one or more respective uplink (UL) channels. In exemplary embodiments, the mobile communication device 140 can be configured to utilize the Access Network Query Protocol (ANQP) to exchange information with the APs 150. Further, one or more of the APs 150 can be Hotspot 2.0 compliant, as defined in the IEEE 802.11u standard. In these examples, the mobile communication device 140 can be configured to exchange backhaul bandwidth and/or data rate information, connectivity information, capability information, and any other connection and/or communication information associated with the AP(s) 150 as would be understood by those skilled in the relevant arts utilizing the ANQP.

In an exemplary embodiment, one or more of the base stations 120 includes one or more processors, circuitry, and/or logic that is configured for communications conforming to the 3rd Generation Partnership Project's (3GPP) Long-Term Evolution (LTE) specification (e.g., the base station is an LTE base station), one or more of the APs 150 includes one or more processors, circuitry, and/or logic that is configured for communications conforming to IEEE's 802.11 WLAN specification (e.g., the AP 150 is a WLAN access point), and one or more of the mobile communication devices 140 include one or more processors, circuitry, and/or logic that is configured for communications conforming to 3GPP's LTE specification and IEEE's 802.11 WLAN specification. The one or more processors, circuitry, and/or logic of the mobile communication device 140 can be further configured for communications conforming to one or more other 3GPP and/or non-3GPP protocols via one or more device-to-device communication networks established with one or more other mobile communication devices. That is, the mobile communication device(s) 140 are configured to wirelessly communicate with the base station(s) 120 utilizing 3GPP's LTE specification, with the AP(s) 150 utilizing IEEE's 802.11 WLAN specification, and/or with one or more other mobile communication devices 140 directly utilizing 3GPP's LTE specification, IEEE's 802.11 WLAN specification, and/or one or more other 3GPP and/or non-3GPP protocols. In this example, the serving cell or sector 110 is an LTE serving cell or sector and the WLANs 112 are WLANs utilizing the 802.11 WLAN specification. In an exemplary embodiment, the communication of the mobile communication device 140 with one or more other mobile communication devices 140 can be a device-to-device communication that bypasses the base station 120, the AP 150, and/or any other base station and/or AP.

Those skilled in the relevant art(s) will understand that the base station(s) 120, the AP(s) 150, and the mobile communication device(s) 140 are not limited to these exemplary 3GPP and non-3GPP wireless protocols, and the base station(s) 120, the AP(s) 150, and/or the mobile communication device(s) 140 can be configured for wireless communications conforming to one or more other 3GPP and/or non-3GPP wireless protocols in addition to, or in the alternative to, the wireless protocols discussed herein. Examples of the mobile communication device 140 include (but are not limited to) a mobile computing device—such as a laptop computer, a tablet computer, a mobile telephone or smartphone, a “phablet,” a personal digital assistant (PDA), and mobile media player; and a wearable computing device—such as a computerized wrist watch or “smart” watch, and computerized eyeglasses. In some embodiments, the mobile communication device 140 may be a stationary device, including, for example, a stationary computing device—such as a personal computer (PC), a desktop computer, a computerized kiosk, and an automotive/aeronautical/maritime in-dash computer terminal.

### 1.1 Base Station

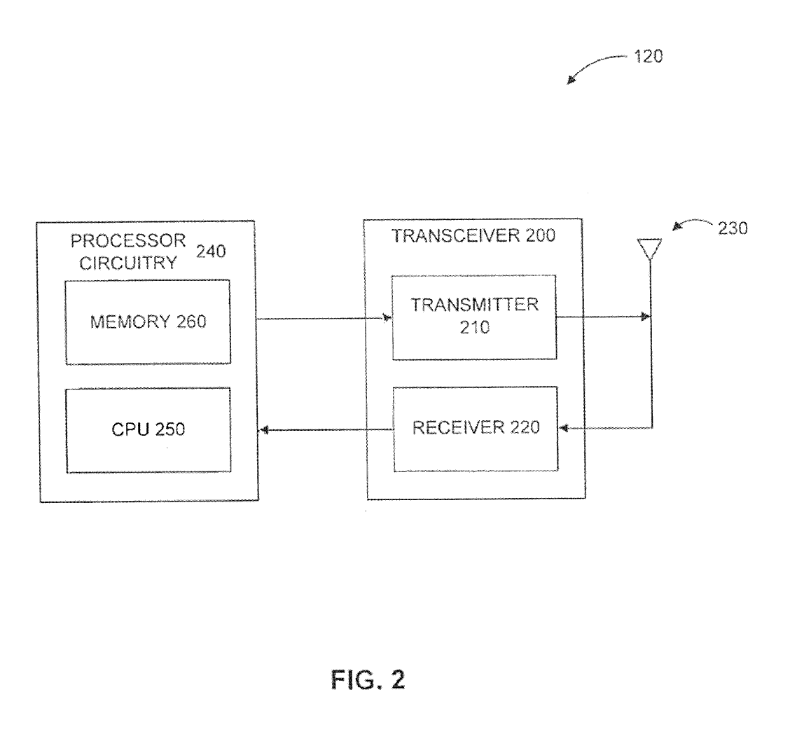

FIG. 2 illustrates the base station 120 according to an exemplary embodiment of the present disclosure. For example, the base station 120 can include a transceiver 200 communicatively coupled to processor circuitry 240. The transceiver 200 includes one or more processors, circuitry, and/or logic that is configured to transmit and/or receive wireless communications via one or more wireless technologies within the communication environment 100. In particular, the transceiver 200 can include a transmitter 210 and a receiver 220 that have one or more processors, circuitry, and/or logic configured to transmit and receive wireless communications, respectively, via one or more antennas 230. Those skilled in the relevant art(s) will recognize that the transceiver 200 can also include (but are not limited to) a digital signal processor (DSP), modulator and/or demodulator, a digital-to-analog converter (DAC) and/or an analog-to-digital converter (ADC), and/or a frequency converter (including mixers, local oscillators, and filters) to provide some examples. Further, those skilled in the relevant art(s) will recognize that the antenna 230 may include an integer array of antennas, and that the antenna 230 may be capable of both transmitting and receiving wireless communication signals. For example, the base station 120 can be configured for wireless communication utilizing a Multiple-input Multiple-output (MIMO) configuration.

In an exemplary embodiment, the transceiver 200 is configured for wireless communications conforming to one or more wireless protocols defined by 3GPP. For example, the transceiver 200 is configured for wireless communications conforming to 3GPP's LTE specification. In this example, the transceiver 200 can be referred to as LTE transceiver 200. Those skilled in the relevant art(s) will understand that the transceiver 200 is not limited to communication conforming to 3GPP's LTE specification, and can be configured for communications that conform to one or more other 3GPP protocols and/or one or more non-3GPP protocols. It should be appreciated that the transceiver 200 can be referred to by one or more other 3GPP and/or non-3GPP protocols in embodiments where the transceiver 200 is configured for such other communications conforming to the other 3GPP and/or non-3GPP protocols.

The processor circuitry 240 can include one or more processors (CPUs) 250 and/or circuits configured to carry out instructions to perform arithmetical, logical, and/or input/output (I/O) operations of the base station 120 and/or one or more components of the base station 120. The processor circuitry 240 can further include a memory 260 (or access an external memory) that stores data and/or instructions, where when the instructions are executed by the processor(s) 250, perform the functions described herein. The memory 260 can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory 260 can be non-removable, removable, or a combination of both.

### 1.2 Access Point

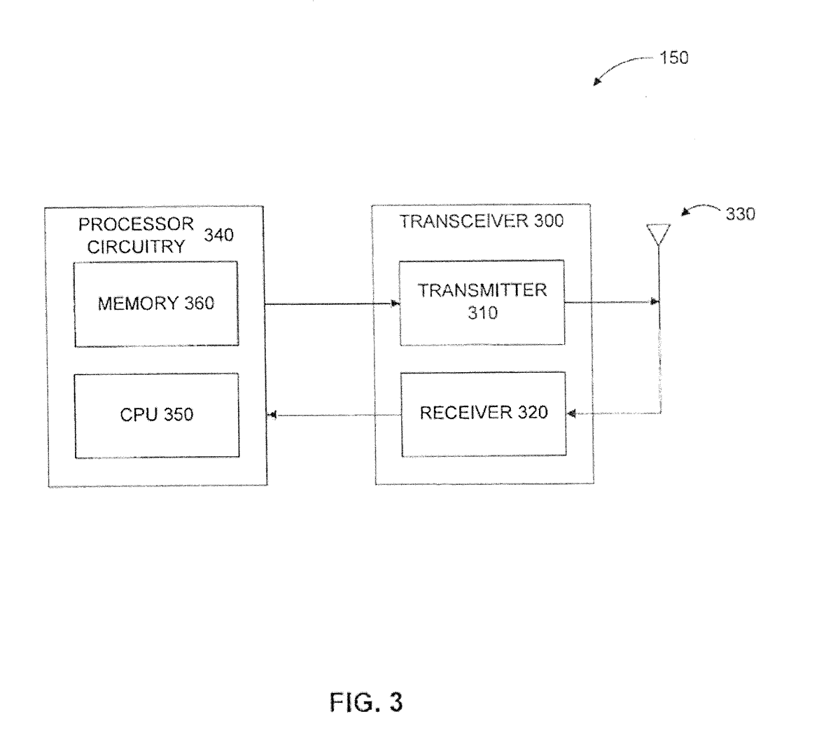

FIG. 3 illustrates the access point (AP) 150 according to an exemplary embodiment of the present disclosure. For example, the AP 150 can include a transceiver 300 communicatively coupled to processor circuitry 340. The transceiver 300 is similar to the transceiver 200 and includes one or more processors, circuitry, and/or logic that is configured to transmit and/or receive wireless communications via one or more wireless technologies within the communication environment 100. In particular, the transceiver 300 can similarly include a transmitter 310 and a receiver 320 that have one or more processors, circuitry, and/or logic configured to transmit and receive wireless communications, respectively, via one or more antennas 330. Those skilled in the relevant art(s) will recognize that the transceiver 300 can also include (but are not limited to) a digital signal processor (DSP), modulator and/or demodulator, a digital-to-analog converter (DAC) and/or an analog-to-digital converter (ADC), and/or a frequency converter (including mixers, local oscillators, and filters) to provide some examples. Further, those skilled in the relevant art(s) will recognize that the antenna 330 may include an integer array of antennas, and that the antenna 330 may be capable of both transmitting and receiving wireless communication signals. For example, the AP 150 can be configured for wireless communication utilizing a Multiple-input Multiple-output (MIMO) configuration.

In an exemplary embodiment, the transceiver 300 is configured for wireless communications conforming to one or more non-3GPP protocols. For example, the transceiver 300 is configured for wireless communications conforming to IEEE's 802.11 WLAN specification. In this example, the transceiver 300 can be referred to as WLAN transceiver 300. Those skilled in the relevant art(s) will understand that the transceiver 300 is not limited to communication conforming to IEEE's 802.11 WLAN specification, and can be configured for communications that conform to one or more other non-3GPP protocols and/or one or more 3GPP protocols. It should be appreciated that the transceiver 300 can be referred to by one or more other 3GPP and/or non-3GPP protocols in embodiments where the transceiver 300 is configured for such other communications conforming to the other non-3GPP and/or 3GPP protocols.

The processor circuitry 340 is similar to the processor circuitry 240 and includes one or more processors, circuitry, and/or logic that is configured to control the overall operation of the AP 150, including the operation of the transceiver 300. The processor circuitry 340 can include one or more processors (CPUs) 350 and/or circuits configured to carry out instructions to perform arithmetical, logical, and/or input/output (I/O) operations of the AP 150 and/or one or more components of the AP 150. The processor circuitry 340 can further include a memory 360 (or access an external memory) that stores data and/or instructions, where when the instructions are executed by the processor(s) 350, perform the functions described herein. The memory 360 can be any well-known volatile and/or non-volatile memory similar to the memory 260 described above. Similarly, the memory 360 can be non-removable, removable, or a combination of both.

### 1.3 Mobile Communication Device

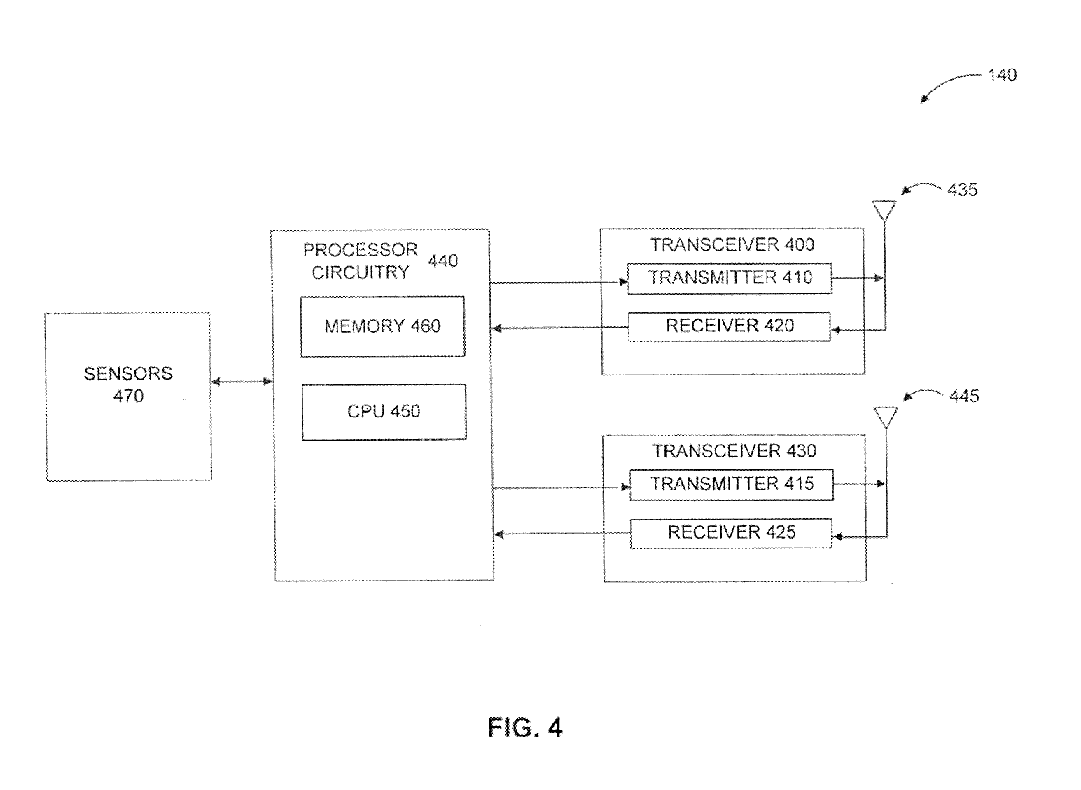

FIG. 4 illustrates the mobile communication device 140 according to an exemplary embodiment of the present disclosure. The mobile communication device 140 can include processor circuitry 440 communicatively coupled to an LTE transceiver 400 and a WLAN transceiver 430. The mobile communication device 140 can be configured for wireless communications conforming to one or more wireless protocols defined by 3GPP and/or one or more non-3GPP wireless protocols. In an exemplary embodiment, the mobile communication device 140 is configured for wireless communication conforming to 3GPP's LTE specification and for wireless communication conforming to IEEE's 802.11 WLAN specification. Those skilled in the relevant art(s) will understand that the mobile communication device 140 is not limited to these exemplary 3GPP and non-3GPP wireless protocols, and the mobile communication device 140 can be configured for wireless communications conforming to one or more other 3GPP and/or non-3GPP wireless protocols in addition to, or in the alternative to, the wireless protocols discussed herein, and/or to a subset of the LTE and WLAN specifications discussed above.

The LTE transceiver 400 includes one or more processors, circuitry, and/or logic that is configured for transmitting and/or receiving wireless communications conforming to 3GPP's LTE specification. In particular, the LTE transceiver 400 can include an LTE transmitter 410 and an LTE receiver 420 that have one or more processors, circuitry, and/or logic configured for transmitting and receiving wireless communications conforming to 3GPP's LTE specification, respectively, via one or more antennas 435. Transceiver 400 need not be limited to LTE, and could operate according to one or more other 3GPP and/or non-3GPP protocols, as will be understood by those skilled in art. The WLAN transceiver 430 includes one or more processors, circuitry, and/or logic that is configured for transmitting and/or receiving wireless communications conforming to IEEE's 802.11 WLAN specification. In particular, the WLAN transceiver 430 can include a WLAN transmitter 415 and a WLAN receiver 425 that have one or more processors, circuitry, and/or logic configured for transmitting and receiving wireless communications conforming to IEEE's 802.11 WLAN specification, respectively, via one or more antennas 445. Transceiver 430 need not be limited to WLAN, and could operate according to one or more other 3GPP and/or non-3GPP protocols, as will be understood by those skilled in art.

Regarding the LTE transceiver 400 and the WLAN transceiver 430, the processes for transmitting and/or receiving wireless communications can include (but are not limited to) a digital signal processor (DSP), modulator and/or demodulator, a digital-to-analog converter (DAC) and/or an analog-to-digital converter (ADC), and/or a frequency converter (including mixers, local oscillators, and filters) to provide some examples. Further, those skilled in the relevant art(s) will recognize that antennas 435 and/or 445 may include an integer array of antennas, and that the antennas may be capable of both transmitting and receiving wireless communication signals. It will also be understood by those skilled in the relevant art(s) that any combination of the LTE transceiver 400 and WLAN transceiver 430, as well as one or more other transceivers, circuits, and/or processors may be embodied in a single chip and/or die.

The processor circuitry 440 includes one or more processors, circuitry, and/or logic that is configured to control the overall operation of the mobile communication device 140, including the operation of the LTE transceiver 400 and WLAN transceiver 430. The processor circuitry 440 can include one or more processors (CPUs) 450 and/or circuits configured to carry out instructions to perform arithmetical, logical, and/or input/output (I/O) operations of the mobile communication device 140 and/or one or more components of the mobile communication device 140. The processor circuitry 440 can further include a memory 460 (or access an external memory) that stores data and/or instructions, where when the instructions are executed by the processor(s) 450, perform the functions described herein. Similarly, the memory 460 can be any well-known volatile and/or non-volatile memory, and can be non-removable, removable, or a combination of both.

In an exemplary embodiment, the mobile communication device 140 includes one or more other transceivers (not shown) configured to communicate via one or more 3GPP protocols, one or more non-3GPP protocols, and/or one or more other well-known communication technologies. In an exemplary embodiment, the one or more other transceivers can be configured for navigational purposes utilizing one or more well-known navigational systems, including the Global Navigation Satellite System (GNSS), the Russian Global Navigation Satellite System (GLONASS), the European Union Galileo positioning system (GALILEO), the Japanese Quasi-Zenith Satellite System (QZSS), the Chinese BeiDou navigation system, and/or the Indian Regional Navigational Satellite System (IRNSS) to provide some examples. Further, the mobile communication device 140 can include one or more positional and/or movement sensors 470 (e.g., GPS, accelerometer, gyroscope sensor, etc.) implemented in (and/or in communication with) the mobile communication device 140. Here, the location and/or movement of the mobile communication device 140 can be determined using one or more transceivers configured for navigation purposes, one or more of the positional and/or movement sensors 470, and/or one or more positional determinations using signal characteristics relative to one or more base stations and/or access points.

### 1.4 Offloading

In an exemplary embodiment, the processor circuitry 440 is configured to offload communications via the LTE or WLAN transceivers 400, 430. For example, the processor circuitry 400 can offload data from one or more base stations 120 and/or APs 150 to one or more other base stations 120 and/or AP 150. Alternatively, the processor circuitry 400 can offload communications via the LTE transceiver 400 to the WLAN transceiver 430, and/or can offload communications via the WLAN transceiver 430 to the LTE transceiver 400. The offloading can be based on one or more offloading policies provided to the mobile device 140 by one or more service providers and received via the LTE transceiver 400 and/or the WLAN transceiver 430. Further, the offloading policies can be stored in the memory 460, and accessed and executed by the CPU 450 to effectuate the offloading of communications. For example, the processor circuitry 440 can be configured to control the mobile communication device 140 to offload communications with the base station 120 to the AP 150.1 based on one or more of the offloading policies. In exemplary embodiments, the offloading policies can include priority information and/or utility information that can be used to determine an appropriate offloading policy to be implemented by the mobile communication device 140. In these examples, the mobile communication device 140 can select an offloading policy from one or more offloading polices based on, for example, utility information associated with the offloading policy.

The offloading of communications with the mobile communication device 140 can be from the base station 120 to the AP 150, from the AP 150 to the base station 120, or a combination of both. For example, the mobile communication device 140 can be configured to offload communications with the base station 120 to the AP 150 based on one or more offloading policies provided to the mobile communication device 140 by one or more service providers. The offloading policies can be application specific for separate applications (e.g. voice, data, background, push applications) operating on the mobile communication device 140. In an exemplary embodiment, the offloading policies are maintained in a policy server that is communicatively coupled to the mobile communication device 140 via one or more communication networks associated with the one or more service providers. For example, the policy server can be communicatively coupled to the base station 120 (via a backhaul connection), and then wirelessly provided to the mobile communication device 140 via the LTE network supported by the base station 120.

The offloading policies can be received by the mobile communication device 140 via the LTE transceiver 400 and/or the WLAN transceiver 430 from the one or more service providers. Further, the offloading policies can be either statically pre-configured on the mobile communication device 140 or dynamically updated by the service provider and provided to the mobile communication device 140. The policies can be stored in the memory 460, and accessed and executed by the CPU 450 to effectuate the offloading of communications between the mobile communication device 140 and base station 120 and/or the AP 150. The offloading policies can include, for example, one or more rules associated with the location of one or more communication networks, priority and/or utility information associated with one or more communication networks and/or one or more applications operable by the mobile communication device 140, the location of the mobile communication device 140, the available communication networks at specified locations, the day of week, the time of day, discovery information corresponding to the various communication networks, and/or any other information as would be apparent to those skilled in the relevant arts.

In operation, the mobile communication device 140 can analyze one or more of the parameters defined in the offloading policy (e.g., utility information) based on the operating state of the mobile communication device 140 (e.g., which applications are currently being utilized by the mobile communication device 140). Based on this analysis, the mobile communication device 140 determines whether to perform an offloading operation to another communication network, and if so, which communications and to what other communication network the communications are to be offloaded to.

### 2. EXEMPLARY NETWORK ENVIRONMENT FOR OFFLOADING

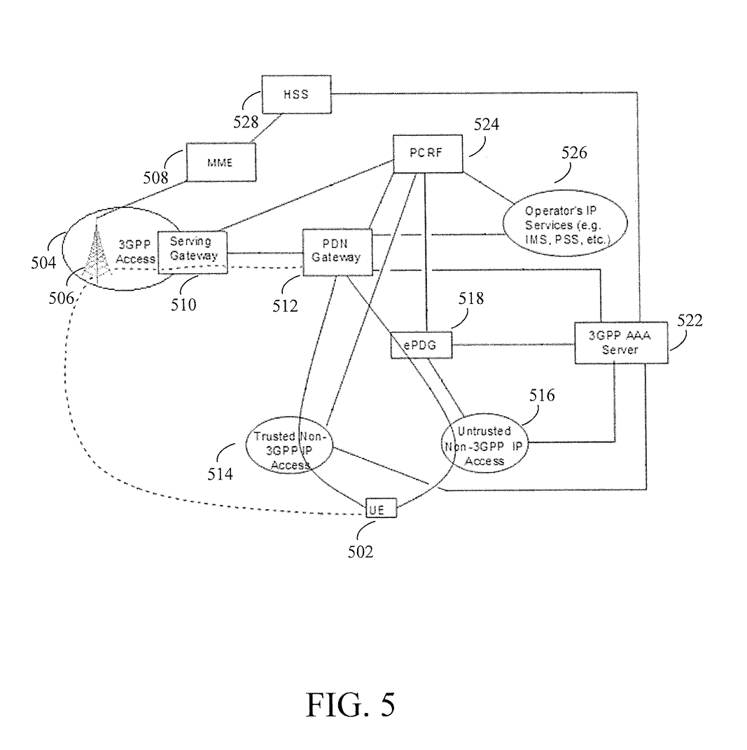

FIG. 5 illustrates an exemplary 3GPP network environment for offloading in accordance with an embodiment of the present disclosure. As shown in FIG. 5, UE 502 can connect to Public Data Network (PDN) Gateway 512 (also referred to as PGW 512) via eNodeB 506 or via Internet Protocol (IP) access 514 or 516. For example, in an embodiment, UE 502 is a mobile communication device, such as mobile communications device 140. In an embodiment, eNodeB 506 is a base station, such as base station 120.

In an embodiment, PGW 512 provides connectivity to UE 502 and is the point of exit and entry for traffic for UE 502 in the network environment of FIG. 5. To connect to PGW 512 via a cellular (e.g., Long Term Evolution (LTE)) connection (e.g., using 3GPP access 504), UE 502 connects to eNodeB 506, which communicates through Serving Gateway (SGW) 510 to reach PGW 512. UE 502 can also connect to PGW 512 over WLAN using a trusted non-3GPP IP access point 514 or an untrusted non-3GPP IP access point 516.

In an embodiment, PGW 512 is coupled to a Policy and Charging Rules Function (PCRF) module 524, which can determines a policy and/or rules for the network shown in FIG. 5. In an embodiment, PCRF module 524 accesses a network operator's IP services 526. In an embodiment, PGW 512 is also coupled to an Evolved Packet Data Gateway (ePDG) 518, which secures data transmission for UE 502 when UE 502 is connected to PGW 512 over untrusted non-3GPP IP access point 516. In an embodiment, PGW 512 and ePDG 518 are coupled to 3GPP Authentication, Authorization, and Accounting (AAA) server 522. In an embodiment 3GPP AAA server 522 is coupled to Home Subscriber Server (HSS) 528, which contains information regarding users and subscriptions. Both 3GPP AAA server 522 and HSS 528 can be used by the network of FIG. 5 to perform authorization functions. In an embodiment, eNodeB 506 communicates with Mobility Management Entity (MME) 508, which can communicate with HSS 528.

### 3. OFFLOADING USING A DETACH AND REATTACH PROCEDURE

Conventional offloading procedures between LTE and WLAN have several challenges. For example, one challenge of conventional offloading procedures is an increase in signaling load caused by a detach procedure followed by a subsequent attach procedure during a handoff.

For example, for a LTE to WLAN handoff, or when WLAN is connected for offloading data from 3rd Generation Partnership Project (3GPP) networks, the following procedures happen at user equipment (UE), such as mobile communications device 140: (1) upon WLAN use, unused Public Data Network (PDN) connections in 3GPP or LTE are disconnected; (2) when the last remaining PDN connection is disconnected, the UE must detach for Evolved Packet Core (EPC) services; and (3) once WLAN dis-association takes place, or the WLAN link is terminated, then the LTE attach procedures start.

This EPC detach procedure followed by a subsequent EPC attach procedure increases signaling load on the network including signaling to the serving eNodeB. Conventional handoff procedures do not provide a way for the UE to avoid this increase in signaling load, as it is unconditionally mandatory according to conventional handoff procedures for the UE to detach after loss of the last remaining PDN connection, when the last EPS bearer context is de-activated.

Because this increased signaling load can be initiated by any UE connected to a core network, it causes a heavy core network impact. The amount of cell selection is also increased because a UE might need to do Public Land Mobile Network selection when (e.g., when returning to 3GPP from WLAN). Additionally, bearers are torn down and re-created during this process.

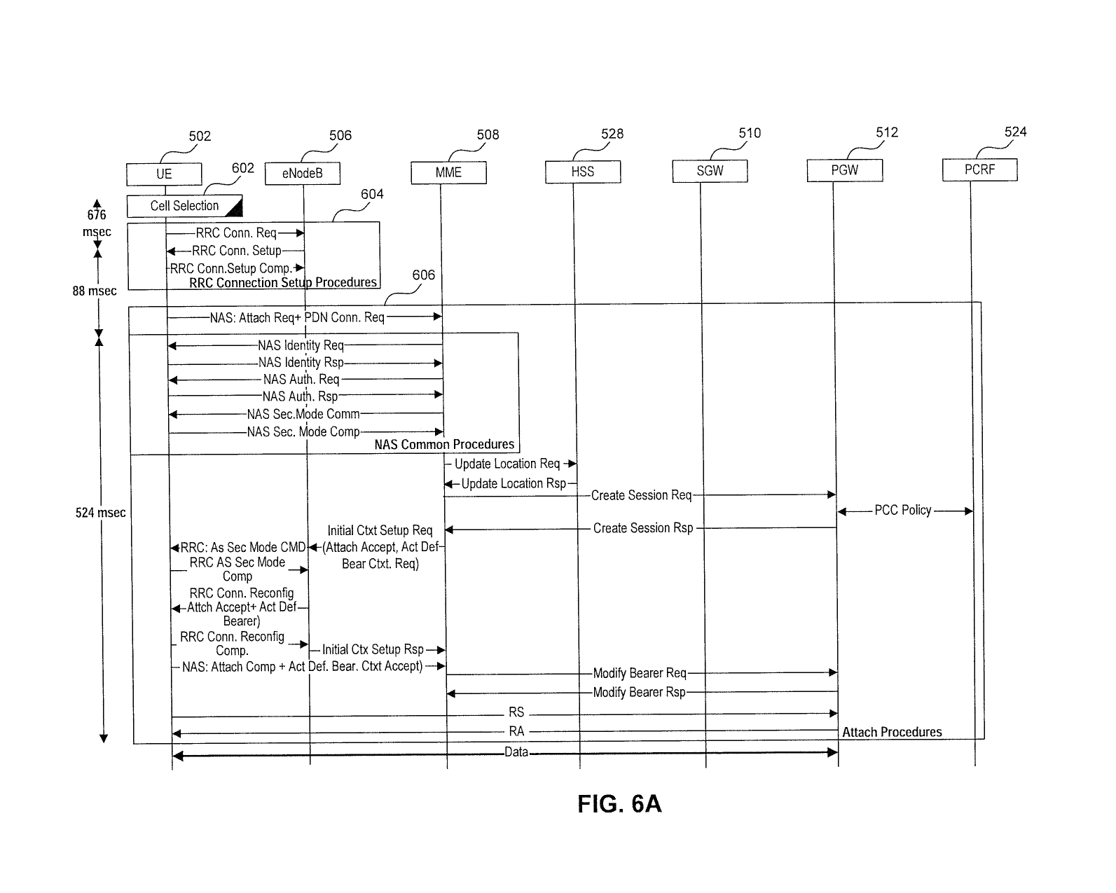

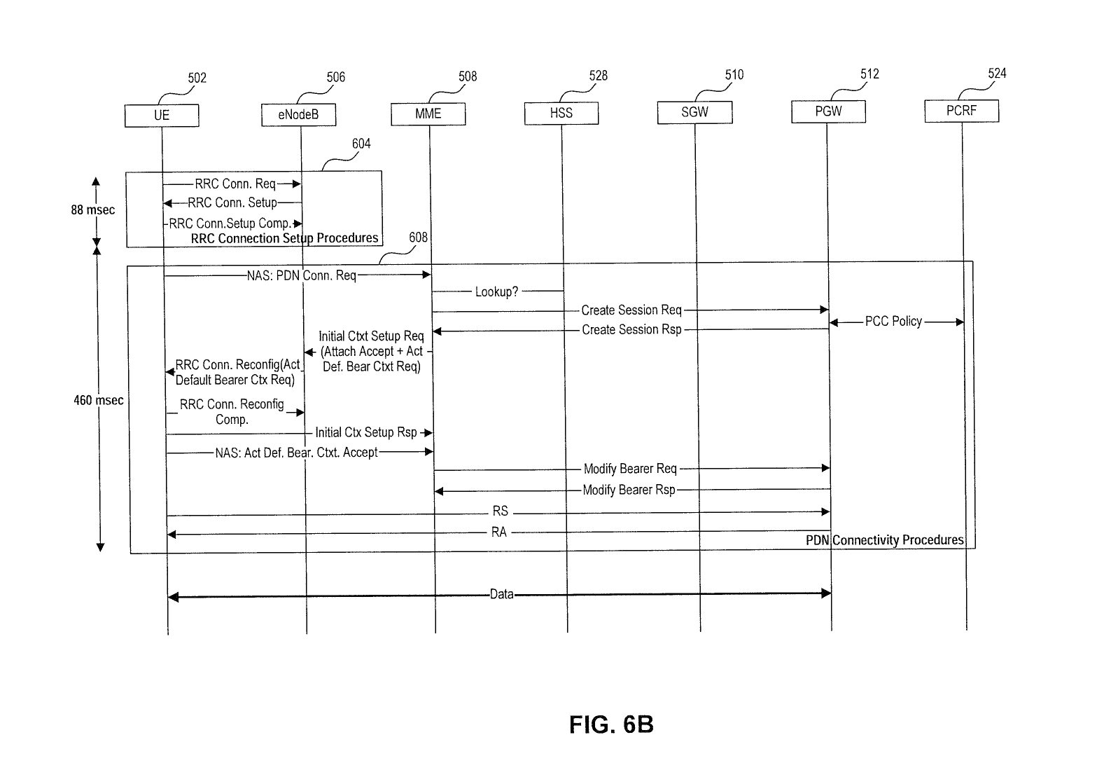

FIGS. 6A and 6B show attach and connection procedures and the corresponding times in milliseconds. FIG. 6A is a diagram illustrating timing for attach procedures. In an embodiment, cell selection procedures 602 take around 676 msec to complete. In an embodiment, radio resource control (RRC) connection procedures 604 take around 88 msec to complete. In an embodiment, attach procedures 606 take around 524 msec to complete. FIG. 6B is a diagram illustrating timing for PDN connection procedures. In an embodiment, PDN connection procedures 608 take around 460 msec to complete. As illustrated by FIG. 6A, attach procedures 606 are a significant source of overhead, and having to detach and reattach according to conventional offloading procedures results in unwanted delay.

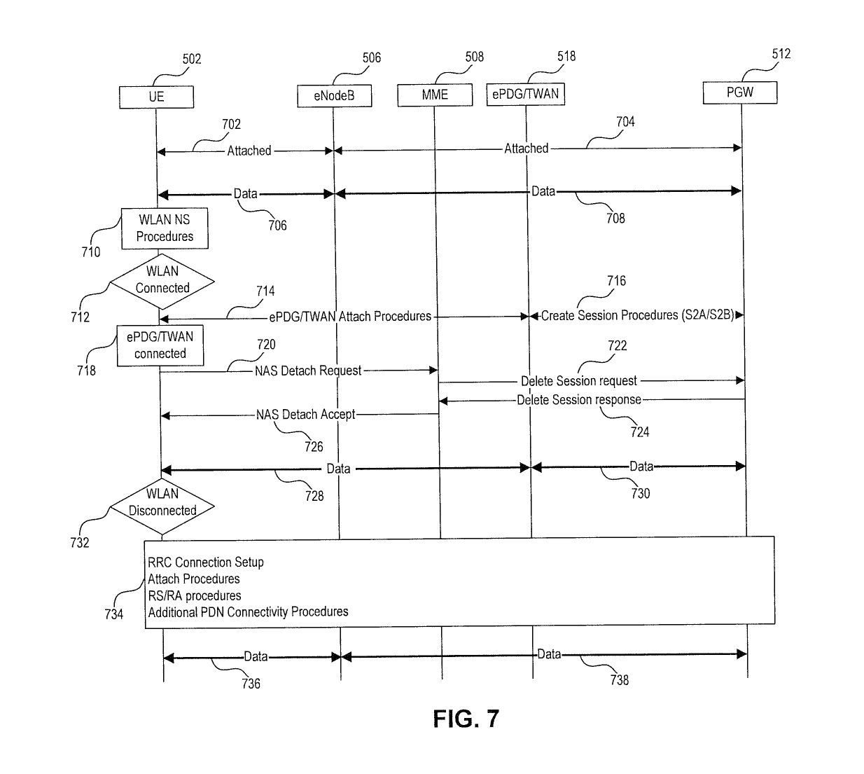

FIG. 7 is a diagram illustrating offloading from LTE to WLAN using a detach and reattach procedure. As shown by FIG. 7, before an offload begins, UE 502 is attached 702 to eNodeB 506, which is attached 704 to PGW 512. During LTE attachment, UE 502 sends data 706 to eNodeB 506, which forwards data 708 to PGW 512. When a WLAN network is available, UE 502 can determined to switch 710 to WLAN and connect 712 to a WLAN network (e.g., via untrusted non-3GPP IP access point 516). In step 714, UE 502 initiates attach procedures with ePDG 518, which creates session procedures 716 with PGW 512, resulting in an ePDG connected state 718.

In step 720, UE 502 sends a detach request 720 (e.g., using Non Access Stratum (NAS) signaling) to MME 508 to initiate a detachment from LTE. MME 508 sends a delete session request 722 to PGW 512, which sends a delete session response 724 back to MME 508. MME 508 then sends a detach accept message 726 to UE 502. Now that UE 502 is connected to WLAN and has detached from LTE, UE 502 can send data 728 to ePDG 518, which can forward data 730 to PGW 512.

Once UE 502 disconnects from WLAN in step 732 (for example, due to loss of an access point), UE 502 has to perform procedures 734 to reconnect to LTE. As shown in FIG. 7, procedures 734 include RRC connection setup procedures 604 and attach procedures 606 shown in FIG. 6A, as well as the PDN connection procedures 608 shown in FIG. 6B. Thus, because UE 502 detaches in steps 720-726, UE 502 has to perform attach procedures 606, which results in unwanted signaling overhead (e.g., about 524 msec of attach signaling).

### 4. OFFLOADING PROCEDURE THAT KEEPS AT LEAST ONE PDN ALWAYS ON LTE

To alleviate these challenges, embodiments of the present disclosure provide systems and methods for offloading. For example, embodiments of the present disclosure provide systems and methods for offloading while keeping at least one PDN always connected to LTE and for suspending unused PDN connection(s). Systems and methods according to embodiments of the present disclosure advantageously avoid the EPC detach and subsequent EPC attach procedures which causes the unwanted signaling load described above. For example, by keeping the context in the network nodes using a suspend state, the consumption of system resources by the suspended PDN connection is minimized.

For example, in an embodiment, when UE 502 communicates with an external network over LTE, UE 502 is configured with at least one Access Point Name (APN) to present to the carrier. The APN acts as an identifier for UE 502 (e.g., as a network identifier and an operator identifier), and the carrier uses the APN information to determine how to create a connection for UE 502 over LTE (e.g., which IP addresses to assign to UE 502, etc.). In an embodiment, UE 502 can use multiple APNs. For example, in an embodiment, UE 502 can use multiple APNs when anchored to PGW 512 or multiple APNs when connected to different PGWs.

A public data network (PDN) is a network established and operated by a telecommunications administration, or a recognized private operating agency, to provide data transmission services. A PDN can be a circuit or packet-switched network that is available to the public and that can transmit data in digital form. In an embodiment, UE 502 can also have multiple PDN connections (e.g., by either having one PDN connection for each APN or by having multiple PDN connections for a single APN). By keeping at least one of these multiple PDN connections connected to LTE while UE 502 is communicating over WLAN, UE 502 can avoid having to perform attach procedures 606 when disconnecting from WLAN and reconnecting to LTE.

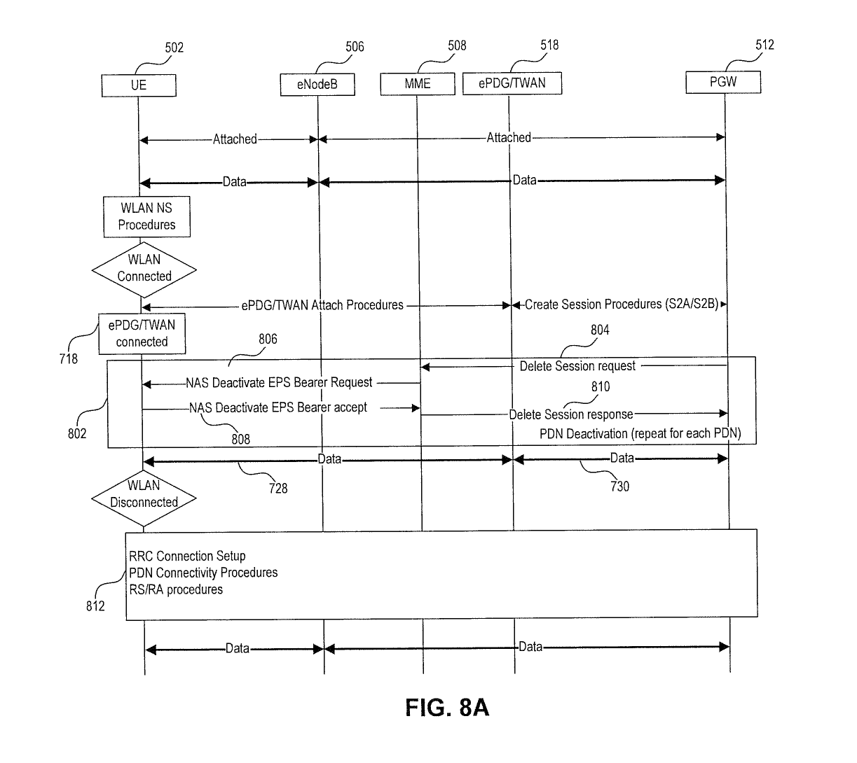

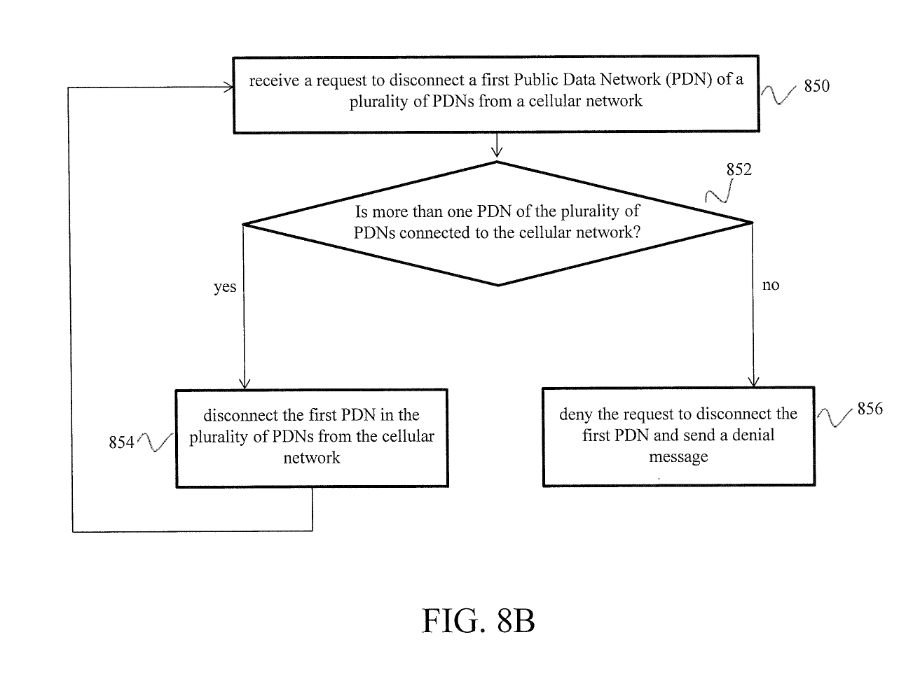

FIG. 8A is a diagram illustrating an offloading procedure that keeps at least one PDN always connected to a cellular network in accordance with an embodiment of the present disclosure. The procedure of FIG. 8A follows the procedure of FIG. 7, except, after ePDG 518 has connected to PGW 512 in step 718, PGW 512 initiates procedures 802 to keep at least one PDN always connected to LTE. Specifically, in procedures 802, PGW 512 deactivates each PDN individually until (at least) one PDN connects UE 502 to LTE. By keeping at least one PDN connected to LTE, attach procedures 606 can be avoided when reconnecting to LTE.

Specifically, PGW initiates procedures 802 for each PDN other than the last PDN. In step 804 of procedures 802, PGW 512 sends a delete session request 804 to MME 508. For example, in an embodiment, PGW 512 detects that UE 502 is connected to WLAN and sends the delete session request 804 to MME 508 in response to detecting that UE 502 is connected to WLAN. In step 806, MME 508 sends a deactivate EPS bearer request 806 to UE 502. For example, in an embodiment, each PDN has a default bearer and can optionally have one or more dedicated bearers. In an embodiment, deactivate EPS bearer request 806 is a request to deactivate the default bearer for a PDN, which would result in disconnecting the PDN from LTE.

In an embodiment, in response to receiving deactivate EPS bearer request 806, UE 502 determines whether it has more than one PDN connection to LTE. If UE 502 determines that UE 502 has more than one PDN connection to LTE, UE 502 deactivates the bearer for a PDN (e.g., the default bearer) and sends a deactivate EPS bearer accept 808 to MME 508. If UE 502 determines that UE 502 does not have more than one PDN connection to LTE (e.g., if only one PDN connection to LTE remains for UE 502), UE 502 denies deactivate EPS bearer request 806 and sends a denial message to MME 508.

In step 810, MME 508 sends a delete session response to PGW 810. In an embodiment, the delete session response 810 lets PGW 512 know whether a PDN has been deactivated (e.g., whether UE 502 denied or accepted deactivate EPS bearer request 806). In an embodiment, PGW 512 can repeat procedures 802 until only one PDN remains connected to LTE for UE 502 (e.g., until PGW 512 receives a delete session response 810 indicating that UE 502 has rejected deactivate EPS bearer request 806). As illustrated by procedures 812, when UE 502 wants to disconnect from WLAN and reconnect to LTE, UE 502 performs RRC connection setup procedures 604 and PDN connection procedures 608 but can avoid performing attach procedures 606 because one PDN remained connected to LTE while UE 502 was connected to WLAN.

FIG. 8B is a flowchart of a method for an offloading procedure that keeps at least one PDN always connected to a cellular network in accordance with an embodiment of the present disclosure. In step 850, UE 502 receives a request (e.g., deactivate EPS bearer request 806 from MME 508) to disconnect a first PDN from a cellular network. In step 852, UE 502 determines whether it has more than one PDN connection to the cellular network. If UE 502 determines that UE 502 has more than one PDN connection to the cellular network, UE 502 disconnects the first PDN from the cellular network in step 854. For example, in an embodiment, UE 502 deactivates the bearer for a PDN (e.g., the default bearer) and sends a deactivate EPS bearer accept 808 to MME 508. If UE 502 determines that UE 502 does not have more than one PDN connection to the cellular network (e.g., if only one PDN connection to the cellular network remains for UE 502), UE 502 denies the request and sends a denial message to MME 508 in step 856. In an embodiment, steps 850-854 can be repeated until UE 502 denies the request in step 856 (i.e., when UE 502 has only one PDN connection to the cellular network).

While FIGS. 8A and 8B describe an offloading procedure whereby UE 502 is configured to deny a request to deactivate a PDN if only one PDN connection to the cellular network remains, it should be understood that UE can deny a request to deactivate a PDN under other circumstances in accordance with an embodiment of the disclosure. For example, in an embodiment, UE 502 can be configured to deny a request to deactivate a PDN once a predetermined number (e.g., 2) of PDN connections remain connected to a cellular network.

In an embodiment, UE 502 includes a memory storing instructions for deactivating PDNs until one PDN remains connected to LTE, as shown in FIGS. 8A and 8B and as described above. For example, in an embodiment, UE 502 includes a memory storing instructions configured to perform steps 806 and 808 of FIG. 8A and steps 850-856 of FIG. 8B until one PDN remains connected to LTE. In an embodiment, UE 502 further includes processor circuitry for executing these instructions. Additionally, in an embodiment, PGW 512 includes a memory storing instructions configured to perform steps 804 and 810 for each PDN and processor circuitry for executing these instructions.

### 5. SUSPEND AND RESUME OFFLOADING PROCEDURE

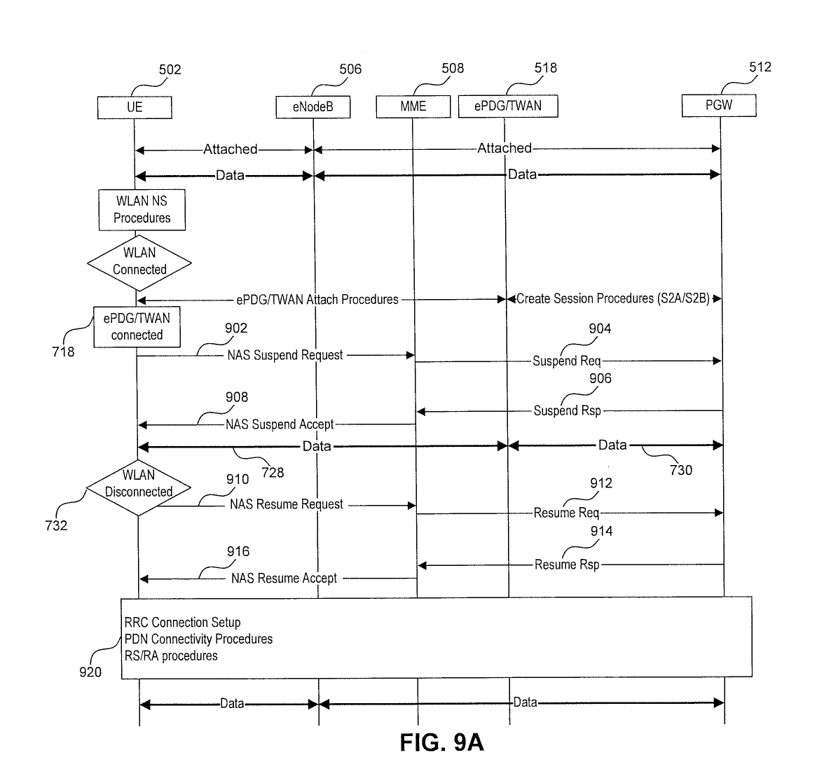

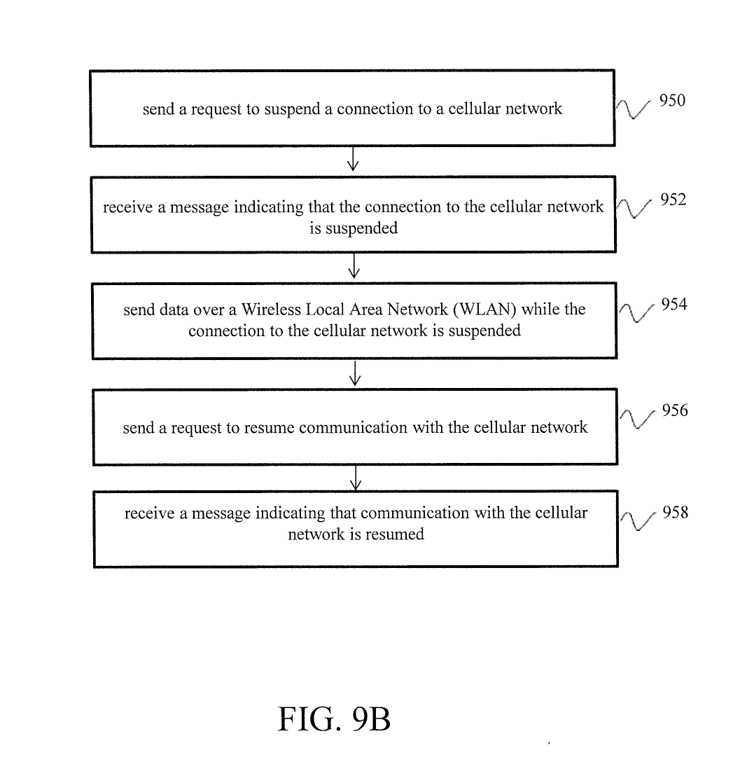

The procedure shown in FIG. 8A advantageously reduces signaling load caused by attach procedures 606 but does require deactivating PDNs individually and determining whether one PDN remains connected to LTE. FIG. 9A provides a suspend and resume procedure that does not require these steps.

FIG. 9A is a diagram illustrating an offloading procedure using a suspend and resume technique in accordance with an embodiment of the present disclosure. The procedure of FIG. 9A follows the procedure of FIG. 7, except, after ePDG 518 has connected to PGW 512 in step 718, UE 502 sends a suspend request 902 to MME 508 to suspend (rather than detach) the LTE connection. In step 904, MME 508 sends a suspend request to PGW 512. In step 906, PGW 512 sends a suspend response to MME 508. In step 908, MME 508 sends a suspend accept message to UE 502. UE 502 can then send data 728 to ePDG 518 over WLAN, and ePDG 518 can send data 730 to PGW 512.

By suspending, rather than detaching, the LTE connection, the procedure shown in FIG. 9A can free up resources, such as buffer space, that would normally be required for keeping the LTE connection active but can preserve the UE context for the LTE connection so that attach procedures 606 will not be required when UE 502 disconnects from WLAN and resumes communication over LTE. In an embodiment, the LTE data plane is suspended, and only a control plane context is kept connected to LTE. For example, while the LTE connection is suspended, data cannot be sent over the LTE connection, but control signals can be sent over the LTE connection. Because of the use of the suspended state, there is no need for re-authentication or key derivation when reconnecting to LTE, as the already generated keys are maintained while the LTE connection is suspended. In an embodiment, these keys would normally be lost once the LTE connection is detached.

When UE 502 wants to disconnect 732 from WLAN and resume the LTE connection, UE 502 can send a resume request to MME 508 in step 910. In step 912, MME 508 sends a resume request to PGW 512. In step 914, PGW 512 sends a resume response to MME 508. In step 916, MME 508 sends a resume accept message to UE 502. UE 502 can then perform procedures 920 to resume communication over LTE. As shown by FIG. 9A, procedures 920 include RRC connection setup procedures 604 and PDN connection procedures 608, but UE 502 can avoid performing attach procedures 606 because the UE context for the LTE connection was preserved by performing the suspend and resume procedure of FIG. 9A rather than, for example, the detach and reattach procedure of FIG. 7. Additionally, the suspend and resume procedure of FIG. 9A advantageously avoids having to disconnect each individual PDN and determine whether one PDN remains connected to LTE, as required by the procedure of FIG. 8A.

FIG. 9B is a flowchart of a method for an offloading procedure using a suspend and resume technique in accordance with an embodiment of the present disclosure. In step 950, UE 502 sends a request to suspend a connection to a cellular network. In step 952, UE 502 receives a message indicating that the connection to the cellular network is suspended. In step 954, UE 502 sends data over a WLAN while the connection to the cellular network is suspended. In step 956, UE 502 sends a request to resume communication with the cellular network. In step 958, UE 502 receives a message indicating that communication with the cellular network is resumed.

In an embodiment, UE 502 includes a memory storing instructions for suspending and resuming connections to an LTE network, as shown in FIGS. 9A and 9B and as described above. For example, in an embodiment, UE 502 includes a memory storing instructions configured to perform steps 902, 908, 910, and 916 in FIG. 9A and steps 950-958 in FIG. 9B. In an embodiment, UE 502 further includes processor circuitry for executing these instructions. Additionally, in an embodiment, PGW 512 includes a memory storing instructions configured to perform steps 904, 906, 912, and 914 and processor circuitry for executing these instructions.

### 6. EXAMPLE COMPUTER SYSTEM ENVIRONMENT

It will be apparent to persons skilled in the relevant art(s) that various elements and features of the present disclosure, as described herein, can be implemented in hardware using analog and/or digital circuits, in computer instructions, through the execution of instructions by one or more general purpose or special-purpose processors, or as a combination of hardware and instructions.

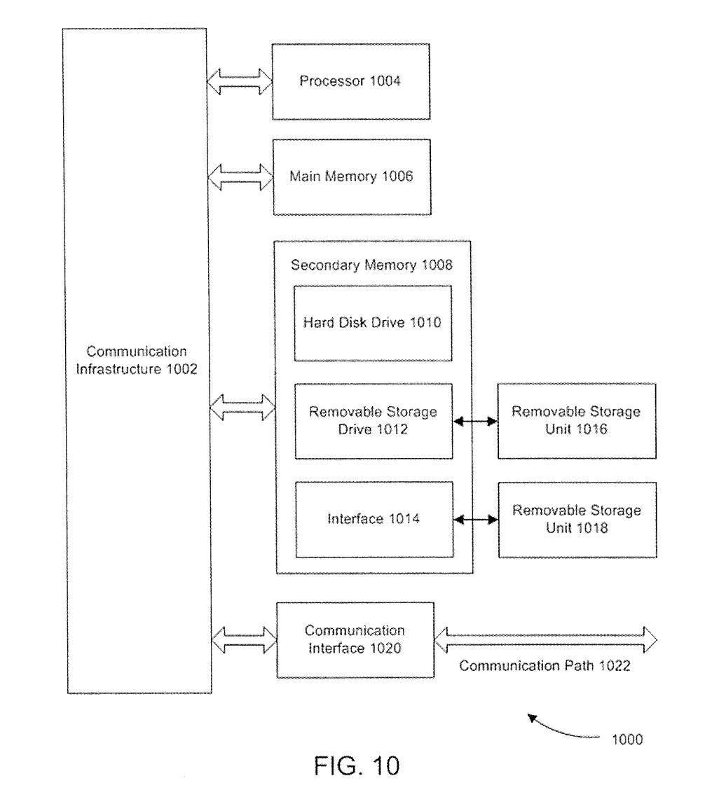

The following description of a general purpose computer system is provided for the sake of completeness. Embodiments of the present disclosure can be implemented in hardware, or as a combination of computer instructions and hardware. Consequently, embodiments of the disclosure may be implemented in the environment of a computer system or other processing system. An example of such a computer system 1000 is shown in FIG. 10. Elements (including servers) depicted in FIGS. 2-5 and procedures depicted in FIGS. 6A-9B may execute on, or implemented with, one or more computer systems 1000.

Computer system 1000 includes one or more processors (or processor circuitry), such as processor 1004. Processor 1004 can be a special purpose or a general purpose digital signal processor. Processor 1004 is connected to a communication infrastructure 1002 (for example, a bus or network). Various implementations are described in terms of this exemplary computer system. After reading this description, it will become apparent to a person skilled in the relevant art(s) how to implement the disclosure using other computer systems and/or computer architectures.

Computer system 1000 also includes a main memory 1006, preferably random access memory (RAM), and may also include a secondary memory 1008. Secondary memory 1008 may include, for example, a hard disk drive 1010 and/or a removable storage drive 1012, representing a floppy disk drive, a magnetic tape drive, an optical disk drive, or the like. Removable storage drive 1012 reads from and/or writes to a removable storage unit 1016 in a well-known manner. Removable storage unit 1016 represents a floppy disk, magnetic tape, optical disk, or the like, which is read by and written to by removable storage drive 1012. As will be appreciated by persons skilled in the relevant art(s), removable storage unit 1016 includes a computer usable storage medium having stored therein computer instructions and/or data.

In alternative implementations, secondary memory 1008 may include other similar means for allowing computer programs or other instructions to be loaded into computer system 1000. Such means may include, for example, a removable storage unit 1018 and an interface 1014. Examples of such means may include a program cartridge and cartridge interface (such as that found in video game devices), a removable memory chip (such as an EPROM, or PROM) and associated socket, a thumb drive and USB port, and other removable storage units 1018 and interfaces 1014 which allow instructions and data to be transferred from removable storage unit 1018 to computer system 1000.

Computer system 1000 may also include a communications interface 1020. Communications interface 1020 allows computer instructions and data to be transferred between computer system 1000 and external devices. Examples of communications interface 1020 may include a modem, a network interface (such as an Ethernet card), a communications port, a PCMCIA slot and card, etc. Instructions and data transferred via communications interface 1020 are in the form of signals which may be electronic, electromagnetic, optical, or other signals capable of being received by communications interface 1020. These signals are provided to communications interface 1020 via a communications path 1022. Communications path 1022 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 1016 and 1018 or a hard disk installed in hard disk drive 1010. These computer program products are means for providing instructions to computer system 1000.

Computer programs (also called computer control logic) are stored in main memory 1006 and/or secondary memory 1008. Computer programs may also be received via communications interface 1020. Such computer programs, when executed, enable the computer system 1000 to implement the present disclosure as discussed herein. In particular, the computer programs, when executed, enable processor 1004 to implement the processes of the present disclosure, such as any of the methods described herein. Accordingly, such computer programs represent controllers of the computer system 1000. Where the disclosure is implemented using instructions, the instructions may be stored in a computer program product and loaded into computer system 1000 using removable storage drive 1012, interface 1014, or communications interface 1020.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### 7. CONCLUSION

It is to be appreciated that the Detailed Description, and not the Abstract, is intended to be used to interpret the claims. The Abstract may set forth one or more but not all exemplary embodiments of the present disclosure as contemplated by the inventor(s), and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Any representative signal processing functions described herein can be implemented using computer processors, computer logic, application specific circuits (ASIC), digital signal processors, etc., as will be understood by those skilled in the art based on the discussion given herein. Accordingly, any processor that performs the signal processing functions described herein is within the scope and spirit of the present disclosure.

The above systems and methods may be implemented as a computer program executing on a machine, as a computer program product, or as a tangible and/or non-transitory computer-readable medium having stored instructions. For example, the functions described herein could be embodied by computer program instructions that are executed by a computer processor or any one of the hardware devices listed above. The computer program instructions cause the processor to perform the signal processing functions described herein. The computer program instructions can be stored in a tangible non-transitory computer usable medium, computer program medium, or any storage medium that can be accessed by a computer or processor. Such media include a memory device such as a RAM or ROM, or other type of computer storage medium such as a computer disk or CD ROM. Accordingly, any tangible non-transitory computer storage medium having computer program code that cause a processor to perform the signal processing functions described herein are within the scope and spirit of the present disclosure.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments.

What is claimed is:

1. A mobile communication device, comprising:
a cellular transceiver configured to wirelessly communicate with a cellular network; and
processor circuitry, coupled to the cellular transceiver, configured to:
receive, using the cellular transceiver, a request to disconnect a first Public Data Network (PDN) of a plurality of PDNs from the cellular network,
determine whether more than one PDN of the plurality of PDNs is connected to the cellular network, and
disconnect the first PDN of the plurality of PDNs from the cellular network in response to determining that more than one PDN of the plurality of PDNs is connected to the cellular network.

2. The mobile communication device of claim 1, wherein the processor circuitry is further configured to:
keep the first PDN of the plurality of PDNs connected to the cellular network in response to determining that more than one PDN of the plurality of PDNs is not connected to the cellular network.

3. The mobile communication device of claim 1, wherein the request to disconnect the first PDN of the plurality of PDNs is a request to disconnect an Evolved Packet System (EPS) bearer for the first PDN of the plurality of PDNs.

4. The mobile communication device of claim 3, wherein the EPS bearer is a default EPS bearer for the first PDN of the plurality of PDNs.

5. The mobile communication device of claim 1, wherein the processor circuitry is further configured to:
send a response indicating whether the first PDN of the plurality of PDNs was deactivated or whether the request was denied.

6. The mobile communication device of claim 1, wherein the processor circuitry is further configured to:
after disconnecting the first PDN of the plurality of PDNs from the cellular network:
receive, using the cellular transceiver, a second request to disconnect a second PDN of the plurality of PDNs from the cellular network,
determine whether more than one PDN of the plurality of PDNs is connected to the cellular network, and
deactivate the second PDN in the plurality of PDNs in response to determining that more than one PDN is connected to the cellular network.

7. A method, comprising:
receiving, using a cellular transceiver, a request to disconnect a first Public Data Network (PDN) of a plurality of PDNs from a cellular network;
determining, using processor circuitry, whether more than one PDN of the plurality of PDNs is connected to the cellular network; and
disconnecting, using the processor circuitry, the first PDN of the plurality of PDNs from the cellular network in response to determining that more than one PDN of the plurality of PDNs is connected to the cellular network.

8. The method of claim 7, further comprising:
keeping the first PDN of the plurality of PDNs connected to the cellular network in response to determining that more than one PDN of the plurality of PDNs is not connected to the cellular network.

9. The method of claim 7, wherein the request to disconnect the first PDN of the plurality of PDNs is a request to disconnect an Evolved Packet System (EPS) bearer for the first PDN of the plurality of PDNs.

10. The method of claim 9, wherein the EPS bearer is a default EPS bearer for the first PDN of the plurality of PDNs.

11. The method of claim 7, wherein the processor circuitry is further configured to:
send a response indicating whether the first PDN of the plurality of PDNs was deactivated or whether the request was denied.

12. The method of claim 7, further comprising:
after disconnecting the first PDN of the plurality of PDNs from the cellular network, determining whether more than one PDN of the plurality of PDNs is connected to the cellular network; and
deactivating a second PDN of the plurality of PDNs in response to determining that more than one PDN of the plurality of PDNs is connected to the cellular network after the first PDN of the plurality of PDNs is disconnected from the cellular network.

13. A mobile communication device, comprising:
a cellular transceiver configured to wirelessly communicate with a cellular network;
a wireless local area network (WLAN) transceiver configured to wirelessly communicate with a WLAN access point;
processor circuitry, coupled to the cellular transceiver and the WLAN transceiver, configured to:
send a request to suspend a connection to the cellular network using the cellular transceiver,
receive a message indicating that the connection to the cellular network is suspended using the cellular transceiver,
send data over the WLAN access point using the WLAN transceiver while the connection to the cellular network is suspended,
send a request to resume communication with the cellular network using the cellular transceiver, and
receive a message indicating that communication with the cellular network is resumed using the cellular transceiver.

14. The mobile communication device of claim 13, wherein the connection to the cellular network is resumed without requiring an attachment procedure for attaching the mobile communication device to the cellular network.

15. The mobile communication device of claim 13, wherein data is not sent over the connection to the cellular network while the connection to the cellular network is suspended.

16. The mobile communication device of claim 13, wherein a control signal is sent over the connection to the cellular network while the connection to the cellular network is suspended.

17. The mobile communication device of claim 13, wherein the mobile communication device maintains a context for the connection to the cellular network while the connection to the cellular network is suspended.

18. The mobile communication device of claim 13, wherein the request to suspend the connection to the cellular network is a Non Access Stratum (NAS) suspend request.

19. The mobile communication device of claim 13, wherein the processor circuitry is configured to send the request to suspend the connection to the cellular network to a Mobility Management Entity (MME).

20. The mobile communication device of claim 13, wherein, after suspending the connection to the cellular network and sending the data over the WLAN access point, the mobile communication device is configured to resume the communication with the cellular network without requiring the mobile communication device to re-authenticate to the cellular network.
